(19) United States
(12) Patent Application Publication
(10) Pub. No.: US 2016/0105727 A1
(43) Pub. Date: Apr. 14, 2016

(54) METHOD AND DEVICE FOR RENDERING BROADCAST SERVICE

(71) Applicant: Electronics and Telecommunications Research Institute, Daejeon (KR)

(72) Inventors: Hyun-Jeong YIM, Daejeon (KR); Byungjun BAE, Daejeon (KR); Woo-Suk KIM, Daejeon (KR); Joungil YUN, Daejeon (KR); Hyoungsoo LIM, Daejeon (KR); Namho HUR, Sejong-si (KR)

(21) Appl. No.: 14/878,810

(22) Filed: Oct. 8, 2015

(30) Foreign Application Priority Data
Oct. 8, 2014 (KR) 10-2014-0136122
Oct. 8, 2015 (KR) 10-2015-0141811

(51) Int. Cl. H04N 21/63; H04N 21/235; H04N 21/647; H04N 21/2343; H04N 21/462; H04N 21/643; H04N 21/242; H04N 21/2665

(52) U.S. Cl. CPC H04N 21/631; H04N 21/242; H04N 21/2353; H04N 21/2665; H04N 21/23439; H04N 21/4622; H04N 21/64322; H04N 21/64738

(57) ABSTRACT

Disclosed is a method and device for providing a broadcasting service, including: acquiring signaling information from a broadcasting signal received from a broadcasting network; acquiring information on a hybrid broadcasting service based upon the signaling information; and determining whether a component to be received through a communication network exists based upon information on the hybrid broadcasting service.

### CROSS-REFERENCE TO RELATED APPLICATION

This application claims priority to and the benefit of Korean Patent Application Nos. 10-2014-0136122 and 1 0-201 5-01 41 81 1 filed in the Korean Intellectual Property Office on Oct. 8, 2014 and Oct. 8, 2015, the entire contents of which are incorporated herein by reference.

### BACKGROUND OF THE INVENTION

(a) Field of the Invention

The present invention relates to a method and device for providing a broadcasting service using a broadcasting network and a communication network.

(b) Description of the Related Art

To provide a next-generation broadcasting service, the advanced television system committee (ATSC) 3.0 and the digital video broadcasting-2^{nd} generation terrestrial (DVB-T2) are in discussion on the IP-based service transfer technology. Recently, there was an agreement on using an IP-based transfer technology and an ISO-based media file format using technology for the service transfer, and there also was an agreement on using a hypertext transfer protocol (HTTP)-based technology in the pull mode using the communication network. Regarding the IP-based next generation broadcasting, as the broadcasting coverage is increased based upon the integration of broadcasting and communication, the hybrid service that may generate various added values has gained increasing attention, and for this reason, the ATSC 3.0 requirements have included the hybrid service as a major service scenario. ATSC made a standard for providing the IP-based broadcasting service. The ATSC mobile/handheld (M/H) (A153 part 3) represents a standard for providing mobile broadcasting service by defining the service protocol stack and the framework on the IP basis. The ATSC non-real-time (NRT) A 106 indicates a standard for providing a non-real-time service by defining an IP-based service framework that is similar to the ATSC M/H, and re-transferring the IP-based contents as Moving Picture Experts Group-2 Transport stream (MPEG-2 TS) data for reverse compatibility with the existing receiver. To transmit information on the broadcasting service transmitted through the File Delivery over Unidirectional Transport (FLUTE) protocol, the ATSC M/H and the ATSC NRT transmit a related signaling table through a specific IP address and a port number called a service signaling channel (SSC). From among the transmitted signaling table, a service map table is a necessary table transmitted in common by the ATSC M/H and the ATSC NRT, and provides an IP address for providing IP-based services and signaling information relating to the service level. However, the current broadcasting standard may only describe the services transmitted through the broadcasting network, and has no method for specifying the transmission methods for respective components. Further, according to the present broadcasting standard, methods for flexibly describing the broadcasting service structure depending on the receiver condition and the service usable condition when providing the broadcasting service do not exist. The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and device for dynamically configuring broadcasting contents that form a broadcasting service according to a broadcasting service rendering environment, a characteristic of contents, and a condition of a transfer network, and providing the same.

An exemplary embodiment of the present invention provides a method for providing a broadcasting service.

The method for providing a broadcasting service includes: acquiring information on a hybrid broadcasting service based upon signaling information of a broadcasting signal received from a broadcasting network; and determining whether a component to be received through a communication network exists based upon network capability, service capability of receiving device and information on the hybrid broadcasting service, and determining the hybrid broadcasting service.

The method may further include, when the component exists, combining at least one broadcasting content included in the broadcasting signal and the component.

The method may further include acquiring synchronization information for synchronizing the hybrid broadcasting service based upon information on the hybrid broadcasting service.

The combining may include performing synchronization the at least one broadcasting contents and the component based upon the synchronization information to provide the hybrid broadcasting service.

The signaling information may be at least one of a protocol version descriptor, a hybrid service descriptor, a service map table, a service profile descriptor, a delivery information descriptor, and a component priority descriptor.

When the signaling information is the protocol version descriptor, the protocol version descriptor may include a protocol identifier field specifying that the broadcasting signal is a broadcasting signal of a next-generation broadcasting service.

When the signaling information is the hybrid service descriptor, the hybrid service descriptor may include a hybrid service mode field for specifying model information of the hybrid broadcasting service.

When the signaling information is the service profile descriptor, the service profile descriptor may include at least one of a profile identifier field, a component number field, and a component identifier field.

When the signaling information is the delivery information descriptor, the delivery information descriptor may include a transmission type field for specifying information on a network for transmitting the component.

When the signaling information is the service map table, the service map table may include a service category field having an extended item of the hybrid broadcasting service.

Another embodiment of the present invention provides a device for receiving a broadcasting service.

The receiving device includes: a broadcasting receiving processor for acquiring signaling information from a broadcasting signal received through a broadcasting network; a service signaling information analyzer for acquiring information on a hybrid broadcasting service based upon the signaling information; and a service manager for determining whether a component to be received through a communication network exists based upon network capability, service capability of the receiving device and information on the hybrid broadcasting service, and determining the hybrid broadcasting service.

The receiving device may further include: a service provider for combining at least one broadcasting content included in the broadcasting signal and the component when the component exists.

The service manager may acquire synchronization information for synchronizing the hybrid broadcasting service based upon information on the hybrid broadcasting service, and transmit the synchronization information to the service provider.

The service provider may perform synchronization the at least one broadcasting content and the component based upon synchronization information to provide the hybrid broadcasting service.

The signaling information may be at least one of a protocol version descriptor, a hybrid service descriptor, a service map table, a service profile descriptor, a delivery information descriptor, and a component priority descriptor.

When the signaling information is the protocol version descriptor, the protocol version descriptor may include a protocol identifier field for specifying that the broadcasting signal is a broadcasting signal of a next generation broadcasting service.

When the signaling information is the hybrid service descriptor, the hybrid service descriptor may include a hybrid service mode field for specifying model information of the hybrid broadcasting service.

When the signaling information is the service profile descriptor, the service profile descriptor may include at least one of a profile identifier field, a component number field, and a component identifier field.

When the signaling information is the delivery information descriptor, the delivery information descriptor may include a transmission type field for specifying information on a network for transmitting the component.

When the signaling information is the service map table, the service map table may include a service category field having an extended item on the hybrid broadcasting service.

### BRIEF DESCRIPTION OF THE DRAWINGS

FIG. 1 shows a hybrid broadcasting service system according to an exemplary embodiment of the present invention.

FIG. 2 shows a protocol version descriptor of a hybrid broadcasting service system according to an exemplary embodiment of the present invention.

FIG. 3 shows a protocol identifier of a protocol version descriptor according to an exemplary embodiment of the present invention.

FIG. 4 shows major information and minor information of a protocol version descriptor according to an exemplary embodiment of the present invention.

FIG. 5 shows a hybrid service descriptor of a hybrid broadcasting service system according to an exemplary embodiment of the present invention.

FIG. 6 shows a hybrid service mode field of a hybrid service descriptor according to an exemplary embodiment of the present invention.

FIG. 7 shows an extended example of a service category field in an SMT according to an exemplary embodiment of the present invention.

FIG. 8(A) and FIG. 8(B) show an example of a component identifier applied to an SMT according to an exemplary embodiment of the present invention.

FIG. 9 shows a service profile descriptor according to an exemplary embodiment of the present invention.

FIG. 10 shows a delivery information descriptor of a hybrid broadcasting service system according to an exemplary embodiment of the present invention.

FIG. 11 shows a transmission type field of a delivery information descriptor according to an exemplary embodiment of the present invention.

FIG. 12 shows a component priority descriptor of a hybrid broadcasting service system according to an exemplary embodiment of the present invention.

FIG. 13 shows a capability descriptor of a hybrid broadcasting service according to an exemplary embodiment of the present invention.

FIG. 14 shows an extended capability code of a capability descriptor according to an exemplary embodiment of the present invention.

FIG. 15 shows a block diagram of a transmitting device of a hybrid broadcasting service system according to an exemplary embodiment of the present invention.

FIG. 16 shows a block diagram of a receiving device of a hybrid broadcasting service system according to an exemplary embodiment of the present invention.

FIG. 17 shows a block diagram of a hybrid broadcasting system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

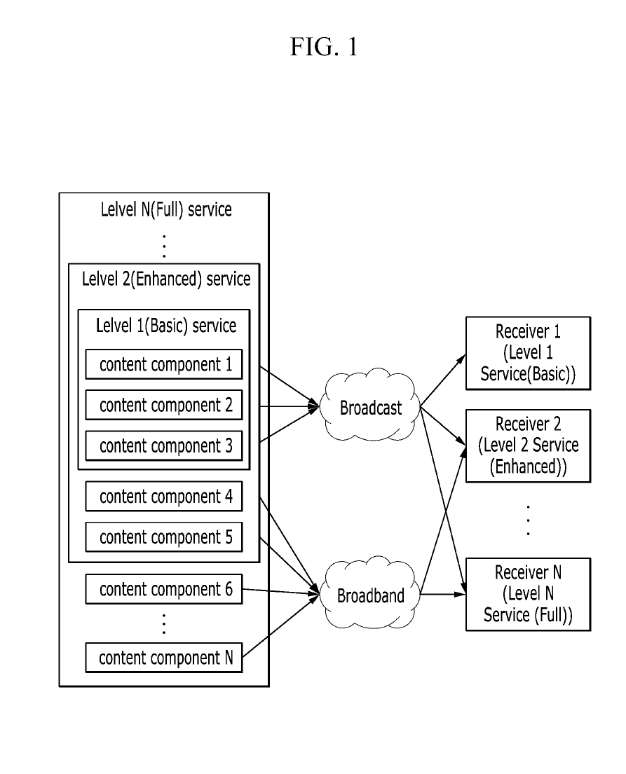

FIG. 1 shows a hybrid broadcasting service system according to an exemplary embodiment of the present invention.

Referring to FIG. 1, the hybrid broadcasting service system includes a transmitting device, a receiving device, and a broadcasting network or a communication network for connecting the transmitting device and the receiving device.

Referring to FIG. 1, a hybrid broadcasting service according to an exemplary embodiment of the present invention is configured with a plurality of contents components (referred to as components hereinafter). Each component represents a set of data that may mean an independent element for configuring a service, and it includes at least one piece of multimedia data. The component is transmitted to the receiving device through the broadcasting network or the communication network, thereby providing the hybrid broadcasting service.

The hybrid broadcasting service according to an exemplary embodiment of the present invention may be subdivided into service units according to the set of components configuring a broadcasting service. For example, the hybrid broadcasting service may be subdivided so that the service may be transmitted in consideration of service processing capability of the receiving device or a condition of a hybrid network connecting the receiving device and the transmitting device. Through service subdivision, one hybrid broadcasting service may be defined as a basic service, an enhanced service with a plurality of stages that may be configured by adding additional contents to the basic service, and a full service for providing entire components. A service component for expressing a service may be defined as a primary component and a supplementary component.

Referring to FIG. 1, a first receiving device may process the basic service so it may receive a basic service through the broadcasting network and may provide the received basic service. A second receiving device and a third receiving device may provide the enhanced service in addition to the basic service. Particularly, since the third receiving device may process the entire services (it may provide full service), it may receive the entire service including the basic service and the enhanced service through the broadcasting network and the communication network, and may provide the full service to the user.

According to an exemplary embodiment of the present invention, signaling information such as a descriptor required for providing the hybrid broadcasting service may be provided. The signaling information according to an exemplary embodiment of the present invention may be transmitted through a program of an existing digital broadcasting standard and a system rule (i.e., program specific information (PSI) or a program and system information protocol (PSIP)), it may be transmitted in a metadata stream or data format, or it may be transmitted as part of the component.

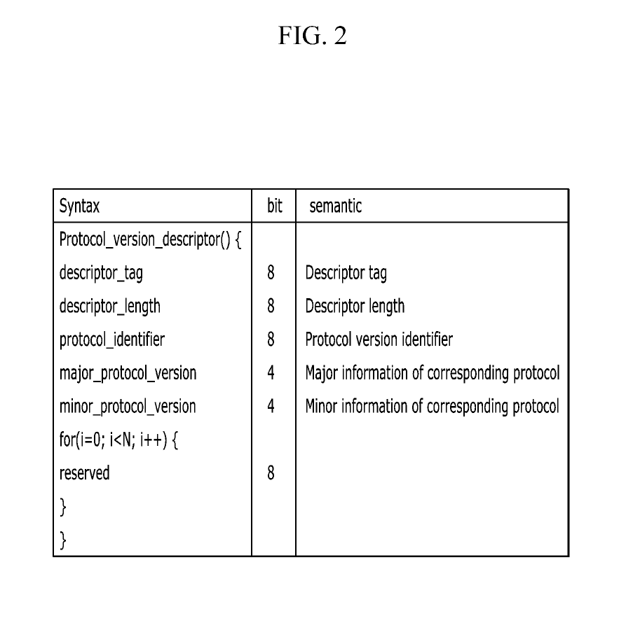

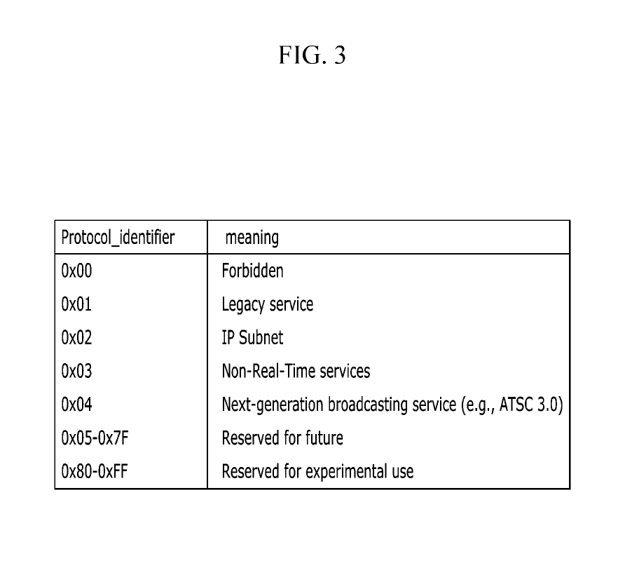

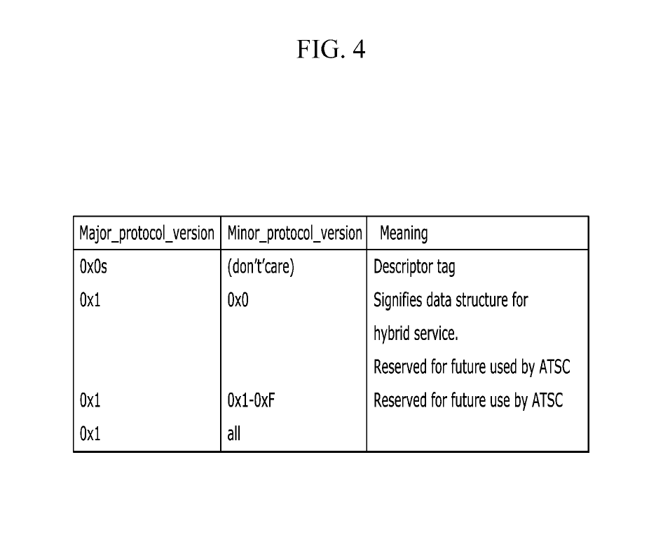

FIG. 2 shows a protocol version descriptor of a hybrid broadcasting service system according to an exemplary embodiment of the present invention, FIG. 3 shows a protocol identifier of a protocol version descriptor according to an exemplary embodiment of the present invention, and FIG. 4 shows major information and minor information of a protocol version descriptor according to an exemplary embodiment of the present invention.

To signal the hybrid broadcasting service, the hybrid broadcasting service system according to an exemplary embodiment of the present invention may use the protocol version descriptor to specify that the hybrid broadcasting service data are applicable to a protocol of a higher version. Version information of the broadcasting protocol described to the protocol version descriptor represents a version of a data structure relating to the broadcasting standard, and it may be used for the receiving device to easily access the service. The protocol version of the broadcasting protocol may be configured with a major protocol version and a minor protocol version. When the protocol version descriptor specifies a major protocol version number that is higher than the version supportable by the receiving device, the receiving device ignores the service relating to the specified protocol version. When the minor protocol version number of the protocol version descriptor specifies a version number that is greater than the version supportable by the receiving device, the receiving device attempts to access a service so as to provide the service.

Through the protocol version descriptor shown in FIG. 2, the protocol identifier shown in FIG. 3, or the major information and the minor information shown in FIG. 4, the signaling of the hybrid broadcasting service according to an exemplary embodiment of the present invention may be transmitted as a new data format to the receiving device. Referring to FIG. 2, the protocol version may be transmitted to the receiving device as a descriptor format, and the protocol version descriptor may describe information (e.g., a descriptor tag, a length of the descriptor, and a protocol version identifier) for specifying a data structure of the transmitted service and information (e.g., major information and minor information of the protocol) for providing information on a detailed structure for respective data structures. Referring to FIG. 2, the protocol version descriptor may include an 8-bit descriptor tag (descriptor_tag), an 8-bit descriptor length (descriptor_length), an 8-bit protocol version identifier (protocol_version_identifier), 4-bit major information (major_protocol_version) of a protocol version, 4-bit minor information (minor_protocol_version) of a protocol version, and an 8-bit reserved bit.

The protocol version descriptor may be used in a subnet level or a service level. When the entire services configuring a virtual channel correspond to the service with a same version, the protocol version descriptor is used in the subnet level, and when services with different protocol versions are provided in the virtual channel, the protocol version descriptor is used in the service level.

Referring to FIG. 3, an exemplary embodiment of a protocol identifier of a protocol version descriptor is shown. For example, when the protocol identifier is ‘0x04,’ the data received by the receiving device may be recognized as data of the next generation broadcasting service (e.g., ATSC 3.0) by the receiving device. That is, at least one of the protocol identifiers of the hybrid broadcasting service according to an exemplary embodiment of the present invention is set for the next generation broadcasting service, so the data received by the receiving device may be indicated to be for the hybrid broadcasting service.

Referring to FIG. 4, an exemplary embodiment of major information and minor information of a protocol version descriptor is shown. For example, when major information of the protocol version descriptor is ‘0x1’ and minor information is ‘0x0,’ the data received by the receiving device may be indicated to be a data structure for the hybrid broadcasting service.

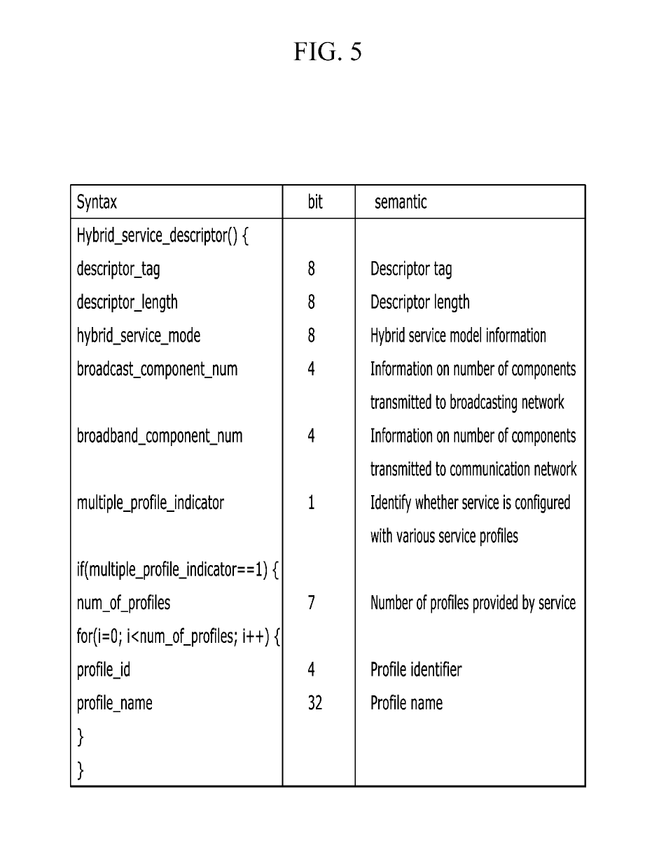

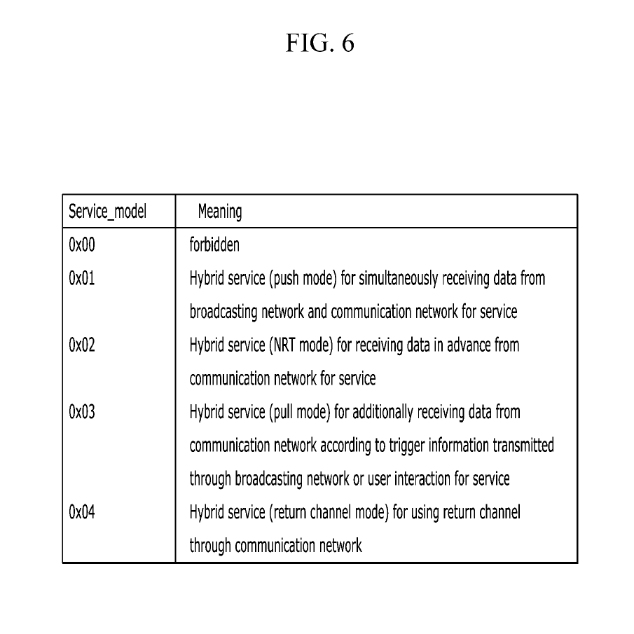

FIG. 5 shows a hybrid service descriptor of a hybrid broadcasting service system according to an exemplary embodiment of the present invention, and FIG. 6 shows a hybrid service mode field of a hybrid service descriptor according to an exemplary embodiment of the present invention.

In the hybrid broadcasting system according to an exemplary embodiment of the present invention, to signal the hybrid broadcasting service, a hybrid service descriptor, a component identifier (component_id), and a service profile descriptor may be used.

The hybrid service descriptor may be used to indicate that the service transmitted to the receiving device is a hybrid broadcasting service. The hybrid service descriptor may specify that the broadcasting service transmitted to the next generation broadcasting protocol is a hybrid broadcasting service, and may provide configuration type information and supplementary information of the hybrid broadcasting service.

The hybrid service descriptor may be used in a level for describing signaling information of a service level. When the component configuring the hybrid broadcasting service is transmitted through the broadcasting network and the communication network, a configuration of the receiving device may be changed according to a time when the component transmitted through the communication network is received by the receiving device so as to provide a service. Therefore, for the efficiency of the hybrid broadcasting service, the hybrid service descriptor may specify hybrid broadcasting service model information through a ‘hybrid service mode (hybrid_service_mode)’ field. FIG. 6 shows an example of a service model specified in a hybrid service mode of a hybrid service descriptor.

The hybrid broadcasting service according to an exemplary embodiment of the present invention may be transmitted to the receiving device through different networks for respective components. Hence, the hybrid service descriptor according to an exemplary embodiment of the present invention may describe information on the component to be transmitted through the broadcasting network and the component to be transmitted through the communication network in the service level, and the receiving device may transmit a component configuration for providing a hybrid broadcasting service and information for using the broadcasting network/communication network to the receiving device. A ‘broadcasting component number (broadcast_component_num)’ field of the hybrid service descriptor may specify a number of components transmitted through the broadcasting network from among the components configuring the hybrid broadcasting service, and a ‘broadband component number (broadband_component_num)’ field may specify a number of components transmitted through the communication network from among the components configuring the hybrid broadcasting service.

The hybrid service descriptor according to an exemplary embodiment of the present invention may specify a number of profiles provided by the hybrid broadcasting service so that the hybrid broadcasting service may be configured with services of a plurality of levels and may be appropriate according to capability of the receiving device and capability of using the communication network. A ‘multiple_profile_indicator’ field of the hybrid service descriptor according to an exemplary embodiment of the present invention may specify whether a profile exists or not, and when the hybrid broadcasting service supports a plurality of profiles, a ‘profile number (num_of_profile)’ field may specify a number of profiles provided by the hybrid broadcasting service. A ‘profile identifier (profile_id)’ field and a ‘profile name (profile_name)’ field may be used to provide identification information and proper name information for respective profiles.

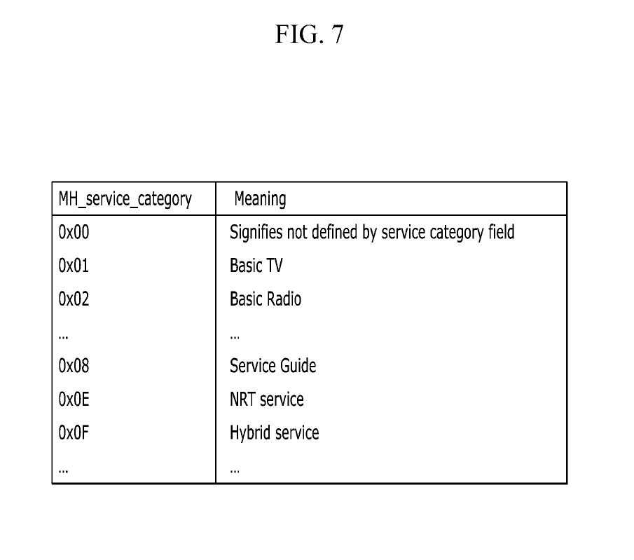

FIG. 7 shows an extended example of a service category field in an SMT according to an exemplary embodiment of the present invention.

When an SMT of the ATSC standard is used to signal a hybrid broadcasting service in the hybrid broadcasting system according to an exemplary embodiment of the present invention, the hybrid broadcasting service may be displayed through a ‘service category (service_category)’ field of the SMT. Referring to FIG. 7, an item on the hybrid broadcasting service is extended in the service category field of the SMT. For example, when the service category field of the SMT has a value of ‘0x0F,’ it may be displayed that the service transmitted to the receiving device is a hybrid broadcasting service.

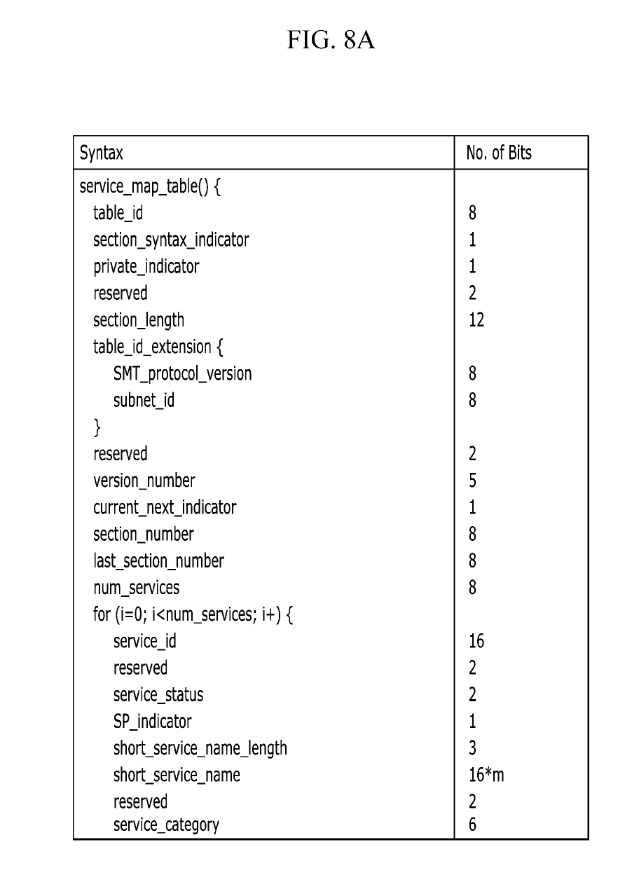

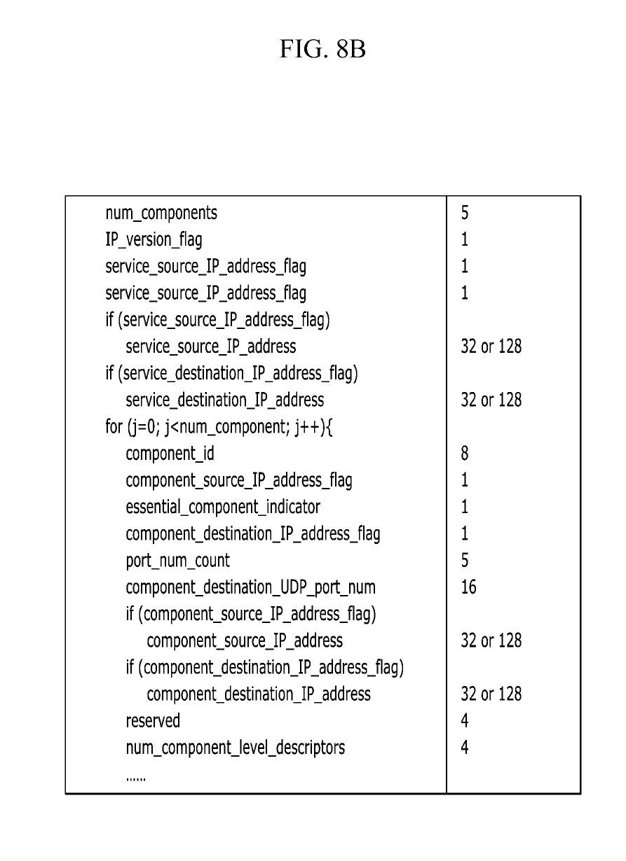

FIG. 8(A) and FIG. 8(B) show an example that a component identifier is applied to an SMT according to an exemplary embodiment of the present invention.

When the SMT of the ATSC standard is used in the hybrid broadcasting system according to an exemplary embodiment of the present invention, identifier information for identifying the respective components may be used so that the transmitting device may notify the receiving device of information on the components included in the respective profiles. Referring to FIG. 8(A) and FIG. 8(B), an 8-bit ‘component identifier (component_id)’ field is inserted into the SMT of the ATSC standard.

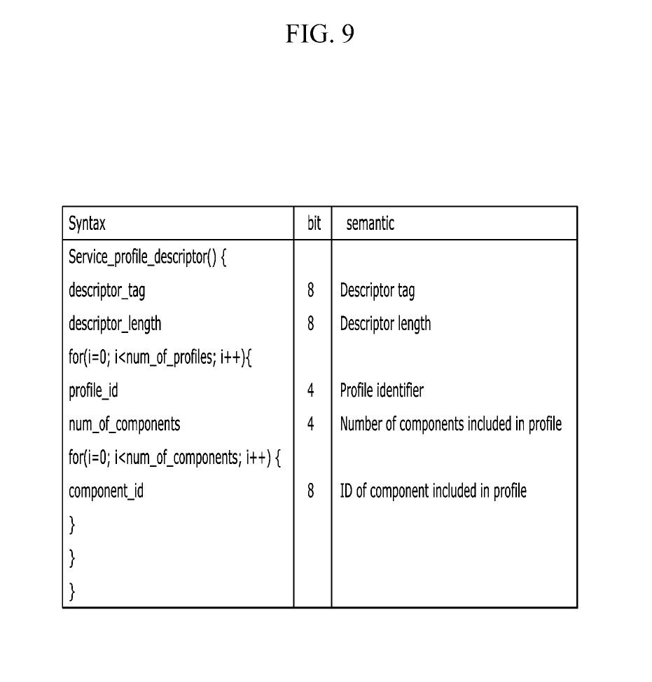

FIG. 9 shows a service profile descriptor according to an exemplary embodiment of the present invention.

The hybrid broadcasting system according to an exemplary embodiment of the present invention may use a service profile descriptor to signal information on the components configuring the respective profiles to the receiving device when the hybrid broadcasting service provides a plurality of profiles. The service profile descriptor may provide information on a component list for configuring the profile specified in the hybrid service descriptor.

Referring to FIG. 9, a ‘profile identifier (profile_id)’ field of the service profile descriptor has the same value as the profile identifier described in the hybrid service descriptor. A ‘component number (num_of_components)’ field of the service profile descriptor may specify a number of components configuring the respective profiles, and a ‘component identifier (component_id)’ field may specify the component included in the profile. The receiving device may receive a component configuring a specific profile through the service profile descriptor and may configure a hybrid broadcasting service.

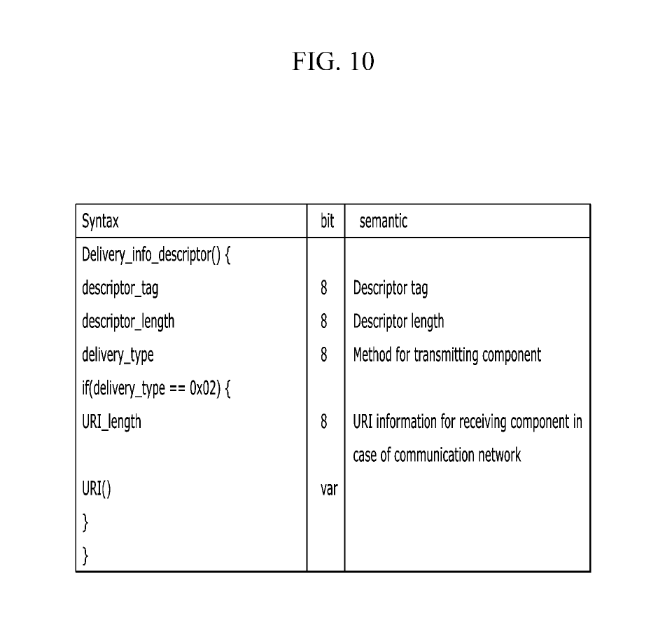

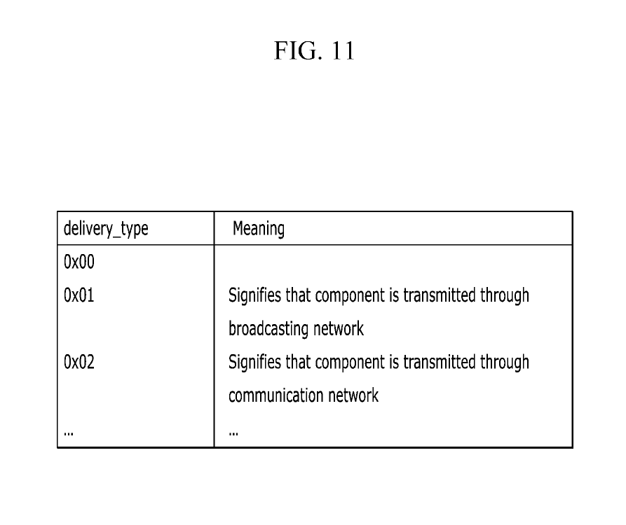

FIG. 10 shows a delivery information descriptor of a hybrid broadcasting service system according to an exemplary embodiment of the present invention, and FIG. 11 shows a transmission type field of a delivery information descriptor according to an exemplary embodiment of the present invention.

A delivery information descriptor used in the hybrid broadcasting service system according to an exemplary embodiment of the present invention describes information on the network for transmitting the component. That is, the delivery information descriptor may transmit information on the network for transmitting the component to the receiving device, and in the case of the component transmitted through the communication network, it may provide information for receiving the component to the receiving device.

Referring to FIG. 10, a ‘delivery type (delivery_type)’ field of the delivery information descriptor is a field for signaling a method for transmitting the service component, and FIG. 11 shows an example of a transfer type field. A delivery information descriptor may include a ‘URI length (URI_length)’ field and a ‘URI( )’ field so as to describe a uniform resource identifier (URI) for receiving the component when the component is transmitted through the communication network. For example, when a specific component is configured with a dynamic adaptive streaming over HTTP (DASH) segment, information on a URI of a media presentation description (MPD) for receiving the DASH segment may be described in the URI length field and the URI( ) field.

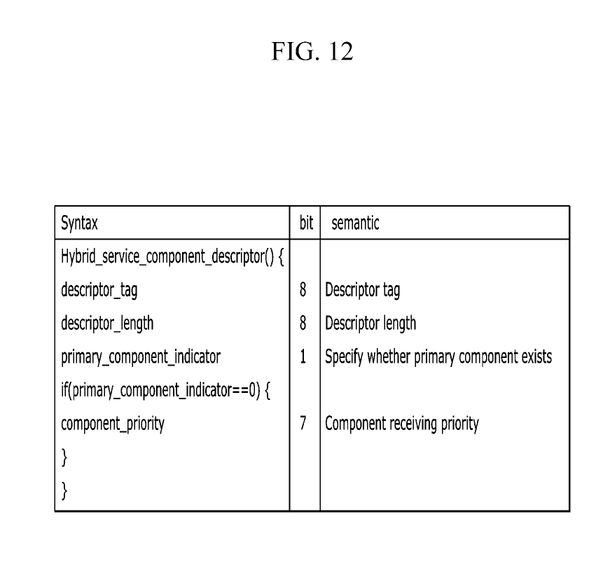

FIG. 12 shows a component priority descriptor of a hybrid broadcasting service system according to an exemplary embodiment of the present invention.

A component priority descriptor of a hybrid broadcasting service system according to an exemplary embodiment of the present invention is used to signal whether the component transmitted to provide a hybrid broadcasting service includes contents that are used as necessary factors for providing a hybrid broadcasting service. The component that must be preferentially received in the broadcasting communication integrating environment so the receiving device may combine data and provide a service when receiving the component that must be preferentially received. That is, a component priority descriptor may be used to generate a service configuration with a level of details for increasing a service providing range and QoS depending on the condition of the receiving device. A component receiving priority may be specified within the same profile through the component priority descriptor, so a device resource and a network resource may be allocated so that the service may be flexibly configured in the receiving device.

Referring to FIG. 12, a ‘primary component indicator (primary_component_indicator)’ field of the component priority descriptor determines whether the component is a primary component or a supplementary component. A number 1 of the primary component indicator field may indicate that the component is a primary component for the receiving device to provide a hybrid broadcasting service, and a number 0 of the primary component indicator field may indicate that the component is a supplementary component for the receiving device to provide a hybrid broadcasting service. A ‘component priority (component_priority)’ field indicates the component for the receiving device to preferentially receive when a plurality of components to be received by the receiving device through the communication network are provided. The component priority field may be used when the component is a supplementary component for providing a hybrid broadcasting service, and for example, when the component priority field has a value that is greater than 1 and the value becomes lesser, the component priority may be defined to be high.

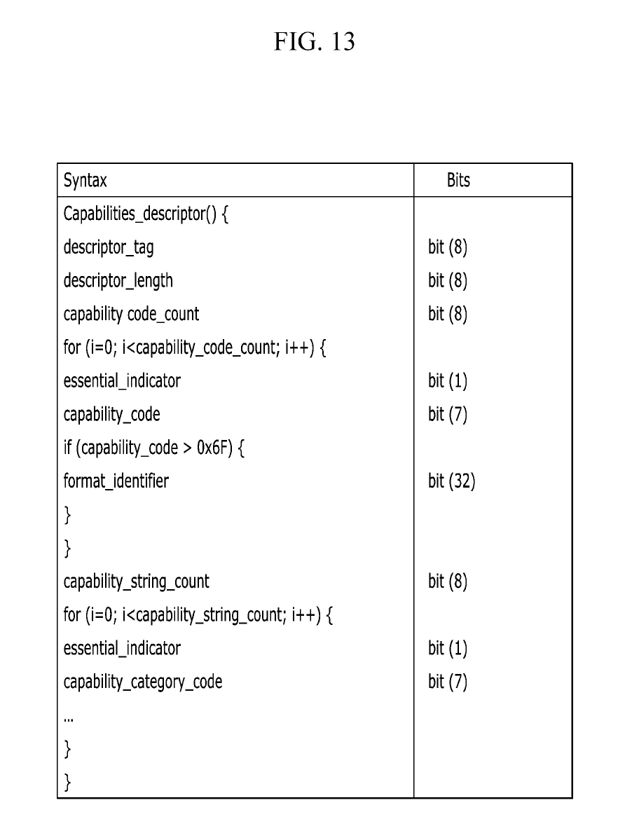

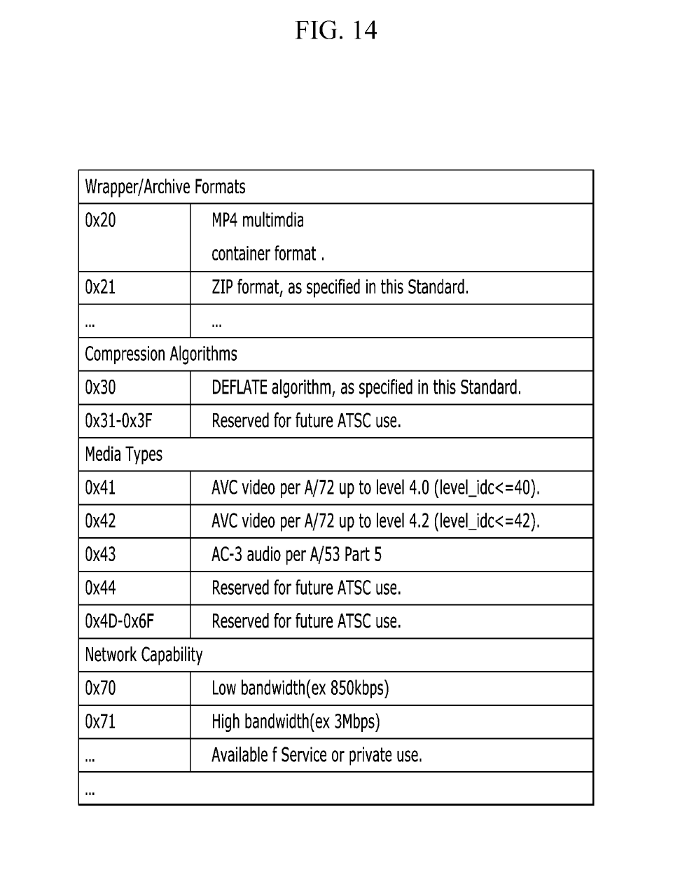

FIG. 13 shows a capability descriptor of a hybrid broadcasting service according to an exemplary embodiment of the present invention, and FIG. 14 shows an extended capability code of a capability descriptor according to an exemplary embodiment of the present invention.

A capability descriptor according to an exemplary embodiment of the present invention determines whether to support or not and provide a service when the receiving device acquires the component of the hybrid broadcasting service. The capability descriptor includes codec information necessary for providing a service, contents format information, minimum network bandwidth information for receiving the component, and device capability information for simultaneously displaying or servicing a plurality of received components. Further, the capability descriptor may provide network information such as contents format information that is necessary for providing a service and a minimum network bandwidth for receiving components so as to determine whether contents are supportable by the receiving device and provide a service when the receiving device acquires contents configuring a hybrid broadcasting service. For example, when the hybrid broadcasting service system according to an exemplary embodiment of the present invention is applied to the ATSC standard, the capability descriptor of an ATSC NRT standard may be extended. FIG. 13 shows an extended capability descriptor when the hybrid broadcasting service system according to an exemplary embodiment of the present invention is applied to the ATSC standard. The ATSC capability descriptor describes a protocol, a compression algorithm, and a media type to be supported by the receiving device for an NRT service or a contents item.

Further, the capability descriptor of the hybrid broadcasting service system according to an exemplary embodiment of the present invention includes an extended ‘capability code (capability_code)’ field so as to describe information on the minimum network bandwidth that must be guaranteed for receiving the component. Referring to FIG. 14, the capability code field of the capability descriptor of the hybrid broadcasting service system according to an exemplary embodiment of the present invention includes a ‘network capability’ category so as to describe network bandwidth information, and it describes a network bandwidth that is to be guaranteed to a minimum as lower information of the network capability category.

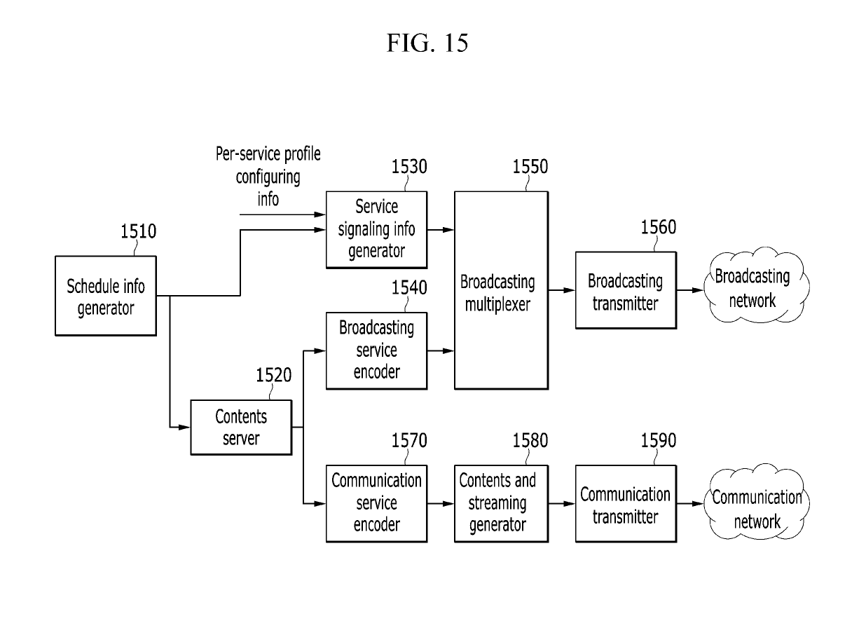

FIG. 15 shows a block diagram of a transmitting device of a hybrid broadcasting service system according to an exemplary embodiment of the present invention.

Referring to FIG. 15, the transmitting device includes a schedule information generator 1510, a contents server 1520, a service signaling information generator 1530, a broadcasting service encoder 1540, a broadcasting multiplexer 1550, a broadcasting transmitter 1560, a communication service encoder 1570, a contents and streaming generator 1580, and a communication transmitter 1590.

The schedule information generator 1510 generates component configuring information on a component configuration for configuring a hybrid service, and per-component transfer schedule information. The schedule information generator 1510 transmits the generated component configuring information and transfer schedule information to the service signaling information generator 1530 and the contents server 1520.

The contents server 1520 transmits appropriate contents to the broadcasting service encoder 1540 or the communication service encoder 1570 based upon per-component transfer schedule information. Therefore, the hybrid service contents to be transmitted through the broadcasting network or communication network may be appropriately encoded according to transfer schedule information.

The service signaling information generator 1530 receives service profile configuring information on a per-service profile configuration, and generates service signaling information based upon component configuring information and service profile configuring information.

The broadcasting service encoder 1540 encodes the contents transmitted by the contents server 1520 into a format appropriate for the broadcasting service protocol, and transmits the encoded broadcasting contents to the broadcasting multiplexer 1550. The service signaling information generator 1530 transmits the generated service signaling information to the broadcasting multiplexer 1550.

The broadcasting multiplexer 1550 multiplexes the service signaling information and the encoded broadcasting contents to generate a broadcasting stream, and transmits the generated broadcasting stream to the broadcasting transmitter 1560.

The broadcasting transmitter outputs the multiplexed broadcasting stream through the broadcasting network.

The communication service encoder 1570 encodes the contents transmitted by the contents server into a format appropriate for the communication service protocol, and transmits the encoded contents to the contents and streaming generator 1580.

The contents and streaming generator 1580 converts the contents that are encoded into the format transmittable through the communication network into contents data or streaming data, and transmits the contents data or the streaming data to the communication transmitter 1590.

The communication transmitter 1590 transmits the contents data or the streaming data to a receiving system through the communication network based upon a request from the receiving system caused by service signaling information.

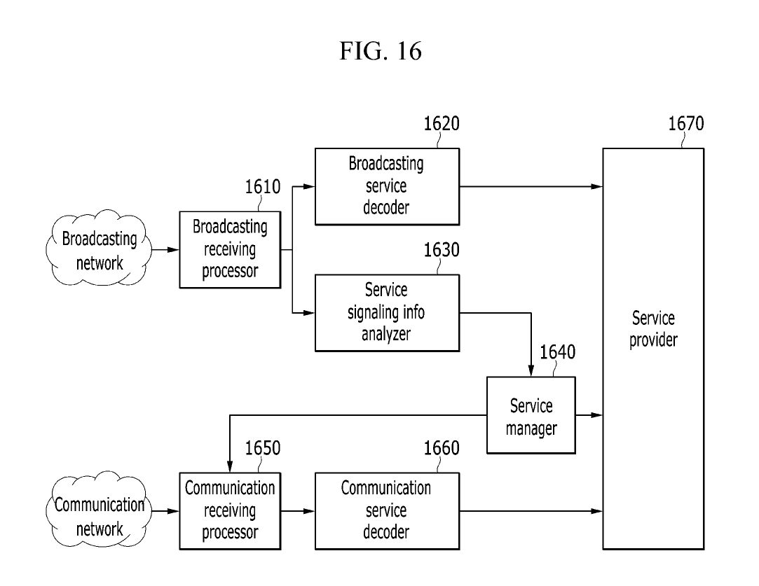

FIG. 16 shows a block diagram of a receiving device of a hybrid broadcasting service system according to an exemplary embodiment of the present invention.

Referring to FIG. 16, the receiving device includes a broadcasting receiving processor 1610, a broadcasting service decoder 1620, a service signaling information analyzer 1630, a service manager 1640, a communication receiving processor 1650, a communication service decoder 1660, and a service provider 1670.

The broadcasting receiving processor 1610 transmits broadcasting contents from among the broadcasting data transmitted through the broadcasting network to the broadcasting service decoder 1620, and transmits service signaling information from among the broadcasting data to the service signaling information analyzer 1630.

The broadcasting service decoder 1620 decodes the broadcasting contents and transmits the decoded broadcasting contents to the service provider 1670.

The service signaling information analyzer 1630 analyzes service signaling information to acquire information (e.g., configuration information on the hybrid broadcasting service) on the hybrid broadcasting service such as service profile configuring information and component configuring information. The service signaling information analyzer 1630 transmits the acquired information on the hybrid broadcasting service to the service manager 1640.

The service manager 1640 determines whether a component to be received through the communication network exists based upon information on service capability of the receiving device and the transmitted hybrid broadcasting service. When the component to be received through the communication network exists, the service manager transmits information on the component to be received through the communication network to the communication receiving processor 1650. That is, the service manager 1640 may determine whether to additionally receive a component through the communication network according to the network condition or the receiving device capability based upon information on the hybrid broadcasting service, and may determine the hybrid broadcasting service that is provided to the user. Further, the service manager 1640 generates synchronization information for synchronizing the hybrid broadcasting service based upon information on the hybrid broadcasting service, and transmits the generated synchronization information to the service provider 1670.

The communication receiving processor 1650 receives information on the component received through the communication network, and requests a component through the communication network based upon information on the received component. The communication receiving processor 1650 receives contents data or streaming data through the communication network, and transmits the received data to the communication service decoder 1660.

The communication service decoder 1660 decodes the data transmitted by the communication receiving processor 1650 and transmits the decoded data to the service provider 1670.

The service provider 1670 provides the hybrid broadcasting service based upon the decoded broadcasting contents received from the broadcasting service decoder 1620, the decoded data received from the communication service decoder 1660, and the synchronization information for the hybrid broadcasting service received from the service manager 1640.

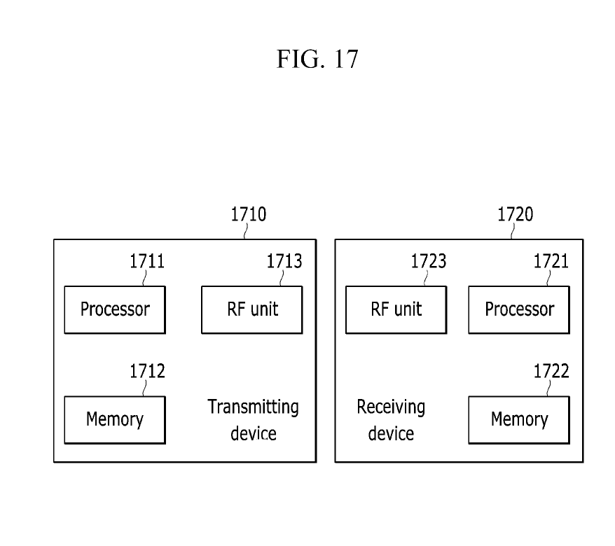

FIG. 17 shows a block diagram of a hybrid broadcasting system according to an exemplary embodiment of the present invention.

Referring to FIG. 17, the hybrid broadcasting system includes a transmitting device 1710 and a receiving device 1720.

The transmitting device 1710 includes a processor 1711, a memory 1712, and a radio frequency (RF) unit 1713. The memory 1712 may be connected to the processor 1711, and may store various types of information for driving the processor 1711 or at least one program performed by the processor 1711. The radio frequency unit 1713 may be connected to the processor 1711 and may transmit/receive radio signals. The processor 1711 may realize a function, a process, or a method proposed in an exemplary embodiment of the present invention. In this instance, a wireless interface protocol layer may be realized by the processor 1711 in a wireless communication system according to an exemplary embodiment of the present invention. An operation of the transmitting device 1710 according to an exemplary embodiment of the present invention may be realized by the processor 1711.

The receiving device 1720 includes a processor 1721, a memory 1722, and a radio frequency unit 1723. The memory 1722 may be connected to the processor 1721 and may store various types of information for driving the processor 1721. The radio frequency unit 1723 may be connected to the processor 1721 and may transmit/receive radio signals. The processor 1721 may realize a function, a stage, or a method proposed in an exemplary embodiment of the present invention. In this instance, a wireless interface protocol layer may be realized by the processor 1721 in a wireless communication system according to an exemplary embodiment of the present invention. An operation of the receiving device 1720 according to an exemplary embodiment of the present invention may be realized by the processor 1721.

In an exemplary embodiment of the present invention, the memory may be provided inside/outside the processor, and may be connected to the processor through various means known to a person skilled in the art. The memory represents a volatile or non-volatile storage medium in various forms, and for example, the memory may include a read-only memory (ROM) and a random access memory (RAM).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing a broadcasting service, comprising:
acquiring information on a hybrid broadcasting service based upon signaling information of a broadcasting signal received from a broadcasting network; and
determining whether a component to be received through a communication network exists based upon network capability, service capability of receiving device and information on the hybrid broadcasting service, and determining the hybrid broadcasting service.

2. The method of claim 1, further comprising,
when the component exists, combining at least one broadcasting content included in the broadcasting signal and the component.

3. The method of claim 2, further comprising
acquiring synchronization information for synchronizing the hybrid broadcasting service based upon information on the hybrid broadcasting service.

4. The method of claim 3, wherein
the combining includes
performing synchronization the at least one broadcasting contents and the component based upon the synchronization information to provide the hybrid broadcasting service.

5. The method of claim 1, wherein
the signaling information is at least one of a protocol version descriptor, a hybrid service descriptor, a service map table, a service profile descriptor, a delivery information descriptor, and a component priority descriptor.

6. The method of claim 5, wherein
when the signaling information is the protocol version descriptor, the protocol version descriptor includes a protocol identifier field specifying that the broadcasting signal is a broadcasting signal of a next-generation broadcasting service.

7. The method of claim 5, wherein
when the signaling information is the hybrid service descriptor, the hybrid service descriptor includes a hybrid service mode field for specifying model information of the hybrid broadcasting service.

8. The method of claim 5, wherein
when the signaling information is the service profile descriptor, the service profile descriptor includes at least one of a profile identifier field, a component number field, and a component identifier field.

9. The method of claim 5, wherein
when the signaling information is the delivery information descriptor, the delivery information descriptor includes a transmission type field for specifying information on a network for transmitting the component.

10. The method of claim 5, wherein
when the signaling information is the service map table, the service map table includes a service category field having an extended item of the hybrid broadcasting service.

11. A device for receiving a broadcasting service comprising:
a broadcasting receiving processor for acquiring signaling information from a broadcasting signal received through a broadcasting network;
a service signaling information analyzer for acquiring information on a hybrid broadcasting service based upon the signaling information; and
a service manager for determining whether a component to be received through a communication network exists based upon network capability, service capability of the receiving device and information on the hybrid broadcasting service, and determining the hybrid broadcasting service.

12. The device of claim 11, further comprising
a service provider for combining at least one broadcasting content included in the broadcasting signal and the component when the component exists.

13. The device of claim 12, wherein
the service manager acquires synchronization information for synchronizing the hybrid broadcasting service based upon information on the hybrid broadcasting service, and transmits the synchronization information to the service provider.

14. The device of claim 13, wherein
the service provider performs synchronization the at least one broadcasting content and the component based upon synchronization information to provide the hybrid broadcasting service.

15. The device of claim 11, wherein
the signaling information is at least one of a protocol version descriptor, a hybrid service descriptor, a service map table, a service profile descriptor, a delivery information descriptor, and a component priority descriptor.

16. The device of claim 15, wherein
when the signaling information is the protocol version descriptor, the protocol version descriptor includes a protocol identifier field for specifying that the broadcasting signal is a broadcasting signal of a next generation broadcasting service.

17. The device of claim 15, wherein
when the signaling information is the hybrid service descriptor, the hybrid service descriptor includes a hybrid service mode field for specifying model information of the hybrid broadcasting service.

18. The device of claim 15, wherein
when the signaling information is the service profile descriptor, the service profile descriptor includes at least one of a profile identifier field, a component number field, and a component identifier field.

19. The device of claim 15, wherein
when the signaling information is the delivery information descriptor, the delivery information descriptor includes a transmission type field for specifying information on a network for transmitting the component.

20. The device of claim 15, wherein
when the signaling information is the service map table, the service map table includes a service category field having an extended item on the hybrid broadcasting service.
